(19) United States
(12) Patent Application Publication
(10) Pub. No.: US 2016/0230792 A1
(43) Pub. Date: Aug. 11, 2016

(54) MATERIAL WITH SELF-LOCKING BARBS

(71) Applicant: Ray Arbesman, Toronto (CA)

(72) Inventors: Ray ARBESMAN, Toronto (CA); Winston MACKELVIE, Knowlton (CA)

(21) Appl. No.: 14/617,658

(22) Filed: Feb. 9, 2015

(51) Int. Cl. F16B 5/07

(52) U.S. Cl. CPC F16B 5/07

(57) ABSTRACT

A textured sheet of ductile material with self-locking barbs extending from a face of the sheet of ductile material. Each self-locking barb is curved so that one side is convex and an opposite side is concave, and a thrust line perpendicular to the face of the sheet lies entirely within each self-locking barb. When a barb is pressed into a substrate, the barb deflects while the barb penetrates into the substrate so that textured sheet is bound to the substrate with a portion of the substrate material above a portion of the barb, providing pull-out resistance. Laminates formed with such textured sheets and methods of producing same are also provided, including a method of pressing the textured sheet into a substrate while the sheet is curved away from the substrate, resulting in fan-out of the barbs and lateral deflection forces on the barbs as they penetrate the substrate.

### FIELD OF THE INVENTION

The present invention relates generally to the mechanical fastening of materials and more particularly to mechanical fastening of materials where one of the materials to be joined is a barbed sheet textured with raised and pointed barbs.

### BACKGROUND OF THE INVENTION

Short, press-in fasteners suffer from low pull-out strength as exemplified in the extreme by a thumbtack pressed into foam. This is because such fasteners rely solely on the friction created by the shank spreading apart the substrate.

Screw-in fasteners on the other hand provide much greater pull-out strength but require more time and effort to rotate the screw into the substrate. The increase in pull-out strength is achieved due to the fact that substrate material is trapped or captured between the threads of the screw while the substrate material remains contiguous with the surrounding substrate material. The result is that considerably more force is required to pull out a screw out as compared to a press-in fastener.

### SUMMARY OF THE INVENTION

The present invention provides a textured sheet of ductile material with barbs extending from a face of the sheet of ductile material. Some or all of the barbs are self-locking barbs. Each self-locking barb is curved so that one side is convex and an opposite side is concave, and a thrust line that is perpendicular to the face of the sheet of ductile material lies entirely within each self-locking barb. As a result, when a self-locking barb is pushed (or pressed) into a substrate, the self-locking barb deflects, increasing the concavity of the concave side of the self-locking barb while the self-locking barb fully penetrates into the substrate so that the textured sheet of ductile material is bound to the substrate with a portion of the substrate material above an end portion of the self-locking barb, thereby providing pull-out resistance.

Some or all of the self-locking barbs may be coated with hard particulate material. Preferably all of the self-locking barbs are coated with hard particulate material. The hard particulate material may be abrasive grains adhered to the barbs. For example, the hard particulate material may include sand, aluminum oxide, silicon carbide, garnet or emery.

The invention also provides a textured sheet of ductile material with barbs extending from a face of the sheet of ductile material, where a portion of the textured sheet is curved so that the textured face in the curved portion of the sheet is concave. The textured sheet can then be bonded to a substrate by pressing the textured face of the sheet into the substrate, causing the curved portion of the sheet to flatten as the barbs are penetrating the substrate so that lateral force is applied to the barbs in the curved portion of the sheet and at least some of the barbs in the curved portion of the sheet deflect while they are entering the substrate. As a result, a portion of the substrate material is above end portions of at least some of the barbs, thereby providing pull-out resistance. There may be multiple such curved portions of the textured sheet.

The invention also provides a method of attaching a sheet of barbed material to a substrate. The sheet of barbed material has a textured face with barbs extending from the face. The substrate is made of a barb-penetrable material and has a substantially flat face. In this method, a portion of the sheet of barbed material is positioned to be proximate to the substrate so that the portion of the sheet of barbed material is curved away from the substantially flat face of the substrate. In this position, the textured face of the portion of the sheet of barbed material is not parallel to the substantially flat face of the substrate and the barbs on the portion of the sheet of barbed material are proximate to the flat face of the substrate. Then the portion of the sheet of barbed material is pressed into the substrate while the sheet of barbed material is being rotated so that the barbed face of the portion of the sheet of barbed material becomes parallel to the substantially flat face of the substrate when the barbs in the portion of the sheet of barbed material are fully embedded in the substrate. The rotation of the sheet of barbed material causes the barbs to deflect as they enter the substrate so that portions of the substrate material are above end portions of at least some, and preferably all, of the barbs in the portion of the sheet of barbed material, thereby providing pull-out resistance.

The pressing of the portion of the sheet of barbed material into the substrate may be performed by a roller. Some or all of the barbs in the portion of the sheet of barbed material may be self-locking barbs. Each self-locking barb is curved so that one side is convex and an opposite side is concave, and a thrust line that is perpendicular to the textured face of the sheet of ductile material lies entirely within each of the self-locking barbs. When each of the self-locking barbs is pressed into a substrate, the self-locking barb deflects, increasing the concavity of the concave side of the self-locking barb while the self-locking barb fully penetrates into the substrate.

The invention also provides a laminate made from a sheet of ductile material and a substrate. The sheet of ductile material has barbs extending from a face of the sheet of ductile material. The sheet of ductile material is mated to a substrate by some or all of the barbs of the sheet of ductile material being embedded in the substrate so that for each of a plurality of the embedded barbs, a portion of the substrate is above an end portion of the embedded barb, thereby providing pull-out resistance. Some or all of the embedded barbs may be self-locking barbs such that each self-locking barb is curved so that one side is convex and an opposite side is concave. In such embodiments, prior to the sheet of ductile material and the substrate being mated, a thrust line that is perpendicular to the face of the sheet of ductile material lies entirely within the self-locking barb and when the self-locking barb is pressed into the substrate, the self-locking barb deflects, increasing the concavity of the concave side of the self-locking barb while the self-locking barb fully penetrates into the substrate.

### BRIEF DESCRIPTION OF THE DRAWINGS

FIG. 1 is a perspective view of a ductile material showing a single pointed barb made of material carved or gouged out of a groove in the surface of the ductile material.

FIG. 2 is a side view showing a single cutting tool tooth advancing from left to right into a sheet of ductile material, carving one groove and raising one barb. Here the barb has a hook-shaped tip, but it may have a pointed tip. The tip shape depends on the sheet material being barbed, the cutting tool operational parameters, and on the tooth tip geometry.

FIG. 3 is a side view showing the sheet of ductile material of FIG. 2 where the tooth has carved the groove and raised the barb, and is retracting from right to left. In the event that a hooked tip is created and a pointed tip is required, a non-cutting projection on the tooth tip irons the curved tip back into a pointed tip. The non-cutting projection may also be used to iron the barb's shank into an optimal curve (such as that shown in FIG. 5).

FIG. 4 is a perspective view of bi-directional barbed sheet material where alternate rows of barbs are cut from opposite directions, which is how the barbed sheet is made.

FIG. 5 is a side cross-sectional view showing a self-locking embodiment using optimally formed barbs (only one shown) showing a barb starting to penetrate a substrate material, where the shank of the barb is curved so as to ensure that its tip is perpendicular and in line with its root so as to offer maximum support to the tip.

FIG. 6 is a side cross-sectional view of the embodiment of FIG. 5 showing the barb further penetrating the substrate material, where forces on the barb have started deflecting the barb from a straight vertical path.

FIG. 7 is a side cross-sectional view of the embodiment of FIG. 5 showing the barb still further penetrating the substrate material, having been self-locked into the substrate by deflection and the capture zone of the substrate above the barb.

FIG. 8 schematically depicts another self-locking embodiment where a barbed sheet is curved against rolls, causing the barbs to naturally fan out from the perpendicular, but then being forced to deflect back just as they mate with the substrate, causing deflection and the desired self-locking action.

FIG. 9 is a close-up of a portion of FIG. 8 showing only the upper barbed sheet with bi-directional barbs and showing how the alternate rows deflect in opposite directions and self-lock by capturing substrate beneath.

FIG. 10 is another self-locking embodiment where barbed sheet material has wave shaped ends. A rigid pressure plate above carries a recessed elastomer pad to apply a mating force with the substrate below.

FIG. 11 shows the embodiment of FIG. 10 where the barbs beneath the pad are embedded in the substrate, and the solid ends of the plate have flattened the waved ends, thereby causing deflection of those barbs locking them into the substrate.

FIG. 11a is an expanded view of the circled portion of FIG. 11 showing the capture zone where self-locking has occurred.

FIG. 12 is a side cross-sectional view of another embodiment of barbed ductile material where the barbs (only one shown) have been surface coated with hard particulate material, such as abrasive grains, that provide the desired deflection forces to self-lock the barbs into the substrate.

FIG. 13 is a side cross-sectional view of barbed ductile material of FIG. 12 showing how the hard particles have randomly deflected the barbs into self-locking when the barbs penetrate a substrate material.

### DETAILED DESCRIPTION

The invention provides textured sheets of a ductile material, such as metal (e.g. steel), with multiple “self-locking barbs” on a face of the sheet of ductile material. The textured sheets are adapted, as described herein, to be used in the formation of laminates where a layer of a substrate material, such as hard foam or wood, is pressed against the textured face with the self-locking barbs which are configured so that the barbs penetrate the substrate and lock the two layers together in a laminate.

The barbs are made to self-lock in a substrate to increase pull-out resistance by the deflection of at least some of the barbs while they are entering the substrate. In one embodiment the shape of the barbs is optimized to ensure straight-in entry after which the design of the barb generates unequal forces causing its path into the substrate to deflect from a straight path. A capture zone is thereby created to lock or trap the barb in the substrate.

Optionally, the barbed sheet may be curved before mating with the substrate, causing the barbs to angularly fan out from perpendicular before they enter the substrate, and then, as they enter, they are forced to transition back to perpendicular causing them to deflect and self-lock.

Adding secondary material to the barbs can also be used to deflect them and cause self-locking.

As used herein, “barb” and “piercing member” describe any type of nail-like or pin-like structure, or hooked structure, raised from the surface of a material by carving, gouging, planing or scraping its surface, such as is described in Canadian patent numbers 1,330,521, 1,337,622, and 2,127,339 and in Canadian patent application number 2,778,455, all of which are hereby incorporated in their entirety herein by reference. The use of such textured materials to form laminates is described in Canadian patent application numbers 2,778,455, 2,821,897 and 2,855,378, and U.S. patent application Ser. Nos. 14/532,739 and 14/533,218, all of which are hereby incorporated in their entirety herein by reference.

Certain forms of barbed materials are available from Nucap Industries of Toronto Canada.

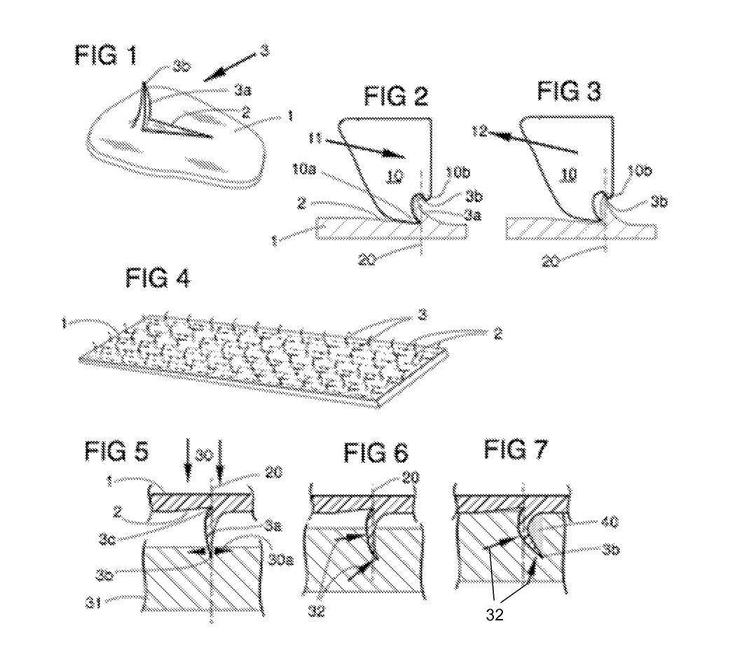

FIG. 1 shows a potion of material with self-locking barbs 1, showing only one barb 3. The barb 3 has a vertical shank 3a and a pointed tip 3b suitable for piercing into substrates. The barb 3 is created from a sheet of ductile sheet material so that the barb 3 is displaced from a shallow, stop-groove 2 carved into the surface portion of the sheet material 1. The sheet material is preferably metal, such as steel, although some plastics may be suitable for certain embodiments.

In FIGS. 2 and 3 a single cutting tooth 10 is shown. The cutting tooth 10 is normally one of a series of cutting teeth arranged in tandem on a blade. As the tooth tip 10a advances from left to right (arrow 11) it carves a groove 2 by severing material along the sides and pushing it forward and up to create barb 3 and its curved face 3a. The barb may have a hook-like or pointed tip, depending on the type and hardness of the sheet material being barbed, and on tool parameters and tooth tip geometry.

FIG. 3 shows the same embodiment where the tooth tip 10a, having carved the groove 2 and raised and formed barb 3, retracts (arrow 12) from right to left. In the event that a hooked tip is created and a pointed tip is desired, a non-cutting projection 10b on the tooth tip irons the curved tip 3b back to a point. The non-cutting projection 10b can also be designed to iron the barb's curvature 32 back into an optimal shape as explained below. In this manner, self-locking barbs can be formed on the surface of the ductile material 1.

FIG. 4 shows a perspective view of barbed sheet material 1 having rows of barbs 3 which are bi-directional so that alternate rows are cut from opposite directions and therefore are shown “leaning” in opposite directions. The tooling that cuts the barbs may have a pack of alternately directed toothed blades that move in opposite directions to cancel cutting forces.

FIGS. 5 to 7 show an embodiment of material with self-locking barbs where the depicted barb is especially formed for self-locking or “self-clinching”. Barb tip 3b, barb root 3c and vertical force 30 are all in alignment, defining a straight, vertical thrust line 20 that lies entirely within the barb shank 3a that fully supports the tip 3b against premature bending at the crucial moment when the tip 3b begins its entry into the substrate 31. In addition, the shank 3a of this especially shaped barb is formed to have a forward curvature 32. The left portion of the barb shown in FIGS. 5 to 7 has a convex outer surface, whereas the right side has a concave outer surface.

Examples of suitable substrates for use, for example, with metal or steel barbed sheet material include wood, particle board, hard foam and other such “expanded” or “composite” substrates, and pliant materials such as softer plastics and metals. In order to be “suitable”, the substrate material should “give way” to a deflecting barb as the barb penetrates it.

In FIG. 5, arrows 30a represent equal forces acting perpendicularly to the barb tip 3b as it enters the substrate 31. In FIG. 6, as the barb goes deeper the forces are now predominately acting on the barb's curve 32, causing it to begin to deflect from vertical. In FIG. 7, the off balanced forces are maximized on curve 32, and deflection of the shank is complete so that it has self-locked into the substrate 31. The concavity of the concave side of the self-locking barb has been increased significantly. Being “locked” means the barb has deflected sufficiently so that the end portion of the barb is under a “capture zone” 40 that lies entirely above the end portion of the barb shank. As a result, a straight pull-out from the substrate of the locked barb is much more difficult because, in addition to having to overcome the normal frictional grip, a straight pull-out will require enough pull to re-form the barb and/or tear and/or displace material in the capture zone 40. The result of this self-locking action is increased pull-apart resistance of the mechanically connected materials.

FIGS. 8 and 9 schematically depict another self-locking barb embodiment where a barbed sheet 1 is fed against curved rolls 100, 100a (or rollers). Curving (bending) the barbed sheet causes the barbs 3 to fan out angularly 21 from their normal perpendicular orientations 20, and to be deflected 22 by off-balance forces generated as they enter the substrate 30, thereby creating multiple capture zones 40 and the desired self-locking action. Different roll diameters will cause different angular fan out angles 21 providing an easy parameter to change for optimizing the self locking action in a range of different substrates having different characteristics, such as substrates of porous wood or hard plastic. The result of this self-locking action is increased pull-apart/separation resistance of the mechanically connected materials. In these embodiments, the barbs do not need to be self-locking barbs as described above, because the unbending of the sheet as the barbs penetrate the substrate produces the forces required to cause the barbs to lock in the substrate so that a portion of the barb has a capture zone of substrate directly above it.

FIGS. 10, 11 and 11a, show another self-locking embodiment where the barbed sheet material 1 is provided with wavy ends 1a that effectively shorten its length so that it ends at point 20a rather than point 20b as it would if it were flat. Barbs 3d (FIG. 10) in these wavy end portions fan in from perpendicular 20 as shown by angled lines 21a. Each wavy portion is curved so that the textured face in the curved portion of the sheet is concave. There may be one or more such curved portions. Preferably on a sheet of material there are at least two curved portions on two opposing sides of the sheet.

A rigid pressure plate A positioned above the barbed material has a recess with side clearance C to hold an elastomer pad B. Barbs 3 under the pad B are first pressed into the substrate 30 as the elastomeric pad B is compressed and squash-flows sideways into clearances C. Further downward travel brings the end portions of the rigid plate A against the wavy ends 1a of the barbed material, which are gradually pressed flat as the pad B is further compressed. This flattening causes lateral movement of the barbs 3d as they simultaneously enter the substrate 30. The effect of the two movements, downward and lateral, causes deflection of the barbs 3d. That is, the barbed material 1 with waved ends 1a starts out shorter and becomes marginally longer while the barbs 3d are entering the substrate 30 and creating capture zones 40, resulting in the desired self-locking action. FIG. 11a is an enlarged view of one end of the same embodiment showing the capture zones 40 of the substrate and the self-locked barbs 3e at their new embedded angle 21a. The result of this self-locking action is increased pull-apart resistance of the mechanically connected materials.

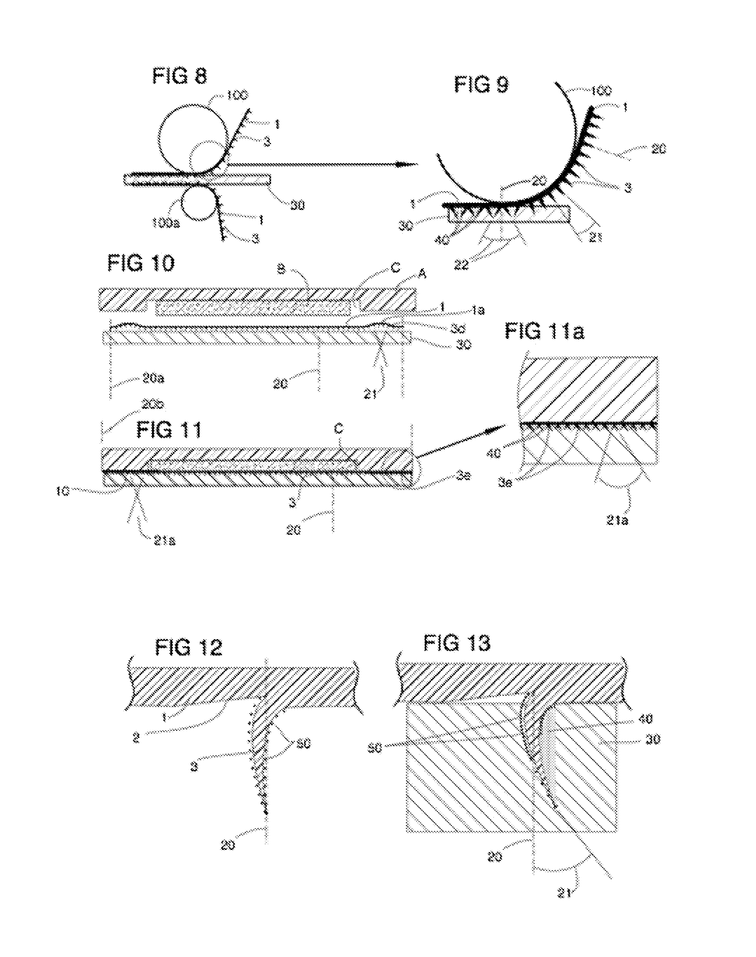

In FIGS. 12 and 13, barbs 3 (one shown) which initially extend vertically 20 from the sheet 1, have been coated with hard particulate material 50, such as abrasive grains. A slurry of grains spread of the barbed material 1 or a pre-applied adhesive followed by dusting/dipping with granular material, will so coat the barbs. FIG. 13 shows that, as the sheet 1 is forced against substrate 30, at least some of the particulate 50 is dragged into the substrate to become firmly embedded, resisting further movement and thereby causing the barbs to deflect angularly 21, making them self-lock beneath the capture zone 40 and thereby adding pull-out resistance to the mechanically connected materials.

The hard particulate material 50 may be, for example, sand, aluminum oxide, silicon carbide, garnet, emery and the like.

In should be noted that in some methods of making laminates as described herein, where a barbed sheet is locked to a substrate by having curved barbs embedded in the substrate with a capture zone of substrate above them to add pull out resistance, while the laminate is being formed, the substrate may be “torn” by lateral movement of the barb shank near the base of the barb caused by lateral forces on the sheet of material. In such cases, it is preferred that the substrate be selected to be a resilient material so that it will, at least in part and preferably mostly, return into the space temporarily created by the tearing so that some of the substrate is above the barb in the region of tearing. This is not an issue in methods where the locking is predominantly achieved by deflection of the barb by lateral forces acting on the barb shanks, for example as the formation methods shown in FIGS. 5-7, and in FIGS. 9 and 10.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description and figures as a whole.

1. A textured sheet of ductile material having a plurality of barbs extending from a face of the sheet of ductile material, a plurality of the plurality of barbs being self-locking barbs such that each self-locking barb is curved so that one side is convex and an opposite side is concave, and wherein a thrust line that is perpendicular to the face of the sheet of ductile material lies entirely within the self-locking barb so that when the self-locking barb is pushed into a substrate, the self-locking barb deflects, increasing the concavity of the concave side of the self-locking barb while the self-locking barb fully penetrates into the substrate so that the textured sheet of ductile material is bound to the substrate and a portion of the substrate material is above an end portion of the self-locking barb, thereby providing pull-out resistance.

2. The textured sheet of ductile material of claim 1, wherein a plurality of the self-locking barbs are coated with hard particulate material.

3. The textured sheet of ductile material of claim 2, wherein the hard particulate material comprises abrasive grains adhered to the barbs.

4. The textured sheet of ductile material of claim 2, wherein the hard particulate material comprises sand, aluminum oxide, silicon carbide, garnet or emery.

5. A textured sheet of ductile material having a plurality of barbs extending from a face of the sheet of ductile material, wherein a portion of the textured sheet is curved so that the textured face in the curved portion of the sheet is concave so that the textured sheet is bondable to a substrate by pressing the textured face of the sheet into the substrate, causing the curved portion of the sheet to flatten as the barbs are penetrating the substrate so that lateral force is applied to the barbs in the curved portion of the sheet and a plurality of the barbs in the curved portion of the sheet deflect while they are entering the substrate so that a portion of the substrate material is above end portions of a plurality of the barbs, thereby providing pull-out resistance.

6. The textured sheet of ductile material of claim 5, wherein a plurality of portions of the textured sheet are curved.

7. A method of attaching a sheet of barbed material to a substrate, the method comprising the steps of:
(a) positioning a portion of a sheet of barbed material so that a plurality of barbs on a textured face of the portion are proximate to a substantially flat face of a substrate;
(b) curving the portion away from the substantially flat face of the substrate so that the textured face is not parallel to the substantially flat face of the substrate; and
(c) embedding the plurality of barbs in the substrate while curving the portion back towards the substrate to position the textured face parallel to the substantially flat face of the substrate.

8. The method of claim 7, wherein embedding the plurality of barbs into the substrate and curving the portion back towards the substrate is performed by a roller.

9. The method of claim 7, wherein at least some of the barbs are self-locking barbs, each self-locking barb curved so that one side is convex and an opposite side is concave, and wherein prior to step (a) thrust lines that are perpendicular to the textured face when the portion is uncurved each lie entirely within a respective one of the self-locking barbs, and wherein in step (c) the self-locking barbs deflect, increasing the concavity of the concave side of each self-locking barb while the self-locking barb embeds into the substrate.

10. A laminate comprising a sheet of ductile material having a plurality of barbs extending from a face of the sheet of ductile material, the sheet of ductile material being mated to a substrate, wherein a plurality of the barbs of the sheet of ductile material are embedded in the substrate so that for each of a plurality of the embedded barbs, a portion of the substrate is above an end portion of the embedded barb, thereby providing pull-out resistance.

11. The laminate of claim 10, wherein a plurality of the embedded barbs are self-locking barbs, each self-locking barb being curved so that one side is convex and an opposite side is concave, and wherein, prior to the sheet of ductile material and the substrate being mated, a thrust line that is perpendicular to the face of the sheet of ductile material lies entirely within the self-locking barb, and when the self-locking barb is pressed into the substrate, the self-locking barb deflects, increasing the concavity of the concave side of the self-locking barb while the self-locking barb fully penetrates into the substrate.

12. The method of claim 7, wherein step (c) comprises deflecting the barbs as they are embedded in the substrate.

13. A method of attaching a sheet of barbed material to a substrate, the method comprising the steps of:
(a) positioning a sheet of barbed material adjacent a face of a substrate, wherein a plurality of barbs on a textured face of the sheet are proximate to the face of the substrate, the barbs each having a root, a shank having a concave side and a convex side, and a pointed tip, wherein a set of thrust lines that are perpendicular to the textured face each lie entirely within a respective one of the barbs;
(b) pushing the barbs into the substrate along the thrust lines to embed the barbs in the substrate; and
(c) while pushing the barbs into the substrate, increasing the concavity of the concave side to create a capture zone of the substrate between the root and the pointed tip of each barb.

14. The method of claim 13, wherein step (b) comprises:
i) pushing the pointed tips into the substrate; and
ii) pushing the shanks into the substrate, and wherein the concavity of the concave side is increased during step (ii).

15. The method of claim 14, wherein the concavity of the concave side is increased only during step (ii).

16. The method of claim 13, wherein the pointed tip is perpendicular to the textured face.

17. The method of claim 13, further comprising: prior to step (b), coating the barbs with a hard particulate material.

18. The method of claim 17, wherein step (b) comprises embedding the hard particulate material in the substrate.

19. The method of claim 7, wherein step (b) comprises causing the barbs to fan out from each other.
